(19) United States
(12) Patent Application Publication
(10) Pub. No.: US 2016/0215134 A1
(43) Pub. Date: Jul. 28, 2016

(54) THERMOPLASTIC FLUORINATED POLYMER COMPOSITION FOR OFF-SHORE PIPES

(71) Applicant: ARKEMA FRANCE, Colombes (FR)

(72) Inventors: Anthony Bonnet, Saint Laurent De Mure (FR); Cyrille MATHIEU, Lyon (FR); Narbara RAMFEL, Barc (FR); Alejandra REYNA-VALENCIA, Evreux (FR)

(73) Assignee: Arkema France, Colombes (FR)

(21) Appl. No.: 14/915,947

(22) PCT Filed: Sep. 1, 2014
(86) PCT No.: PCT/FR2014/052150

§ 371 Date: Mar. 2, 2016

(30) Foreign Application Priority Data
Sep. 2, 2013 (FR) 1358385

(51) Int. Cl. C08L 27/16; C08J 3/18; F16L 11/04; C08J 3/00

(52) U.S. Cl. CPC C08L 27/16; C08J 3/005; C08J 3/18; F16L 11/04; C08J 2327/16; C08J 2427/16; C08L 2205/03; C08L 2205/02

(57) ABSTRACT

The invention relates to a composition comprising:
from 60 to 80% by weight of a polyvinylidene fluoride;
from 10 to 30% by weight of a copolymer of vinylidene fluoride and of a comonomer;
a plasticizer; and
from 3 to 20% by weight of fibers;
and also to the use of this composition in the manufacture of various articles, such as pipes.

### FIELD OF THE INVENTION

The present invention relates to a composition of thermoplastic fluorinated polymers, to processes for the manufacture of this composition and to the products which are to be manufactured from this composition, in particular the polymeric sheaths of the flexible pipes used in transportation of fluids of oil (off-shore and on-shore) or gas operations.

### TECHNICAL BACKGROUND

The transportation of chemicals in the liquid or gas state in pipes exhibits numerous advantages: it is more economical, once the infrastructure has been installed, it permits transportation of large volumes, it ensures peat security of supply, by virtue of a steady output, and, finally, it is a safer means than rail or road.

The use is known, for the transportation of liquid or gas products, of metal or plastic pipes or also of metal pipes coated with one or more polymeric layers. Depending on the fluid to be transported, these pipes have to meet multiple requirements, in particular as regards the properties of mechanical strength (in particular impact strength), of elasticity, of creep strength, of fatigue strength, of resistance to swelling, of chemical resistance (resistance to corrosion, to oxidation, to ozone, to chlorinated products and the like) and of thermal resistance.

For example, pipes comprising one or more metal components guaranteeing the mechanical stiffness but which are not leaktight to the fluids transported (for example, components made of steel or of cast iron), and also various layers based on polymeric compositions, for ensuring leaktightness to the fluids transported and also thermal insulation, are known. Typically, in the case of the polymeric layers, the thickness/diameter ratio is of the order of 1/10. These polymeric compositions can be based on polyethylene but this limits the operating temperature of the pipes to at most 60° C. They can also be based on fluorinated polymers, such as polyvinylidene fluoride (PVDF), suitable for higher operating temperatures, up to 130° C., and exhibiting good chemical resistance and good thermal resistance. However, PVDF is very stiff and, for this reason, PVDF homopolymers are often formulated or used as a blend with copolymers based on vinylidene fluoride (VDF) and optionally plasticizer, in order to reduce the stiffness thereof.

Flexible pipes are also used for the transportation of oil or natural gas extracted from off-shore or on-shore deposits. These pipes are formed of multilayer structures comprising in particular polymeric sheaths and metal reinforcing layers or reinforcing layers made of composite materials.

The flexible pipes comprise, from the inside towards the outside:
at least one internal leaktightness pipe in contact with the transported fluid, consisting of a polymeric material,
one or more reinforcing layers surrounding said internal leaktightness pipe, and
an external protected sheath.

The document BE 832851 describes fluorinated elastomers comprising a molar proportion of 50 to 85% of VDF and of 15 to 25% of hexafluoropropylene (HFP), i.e. a proportion by weight of 47 to 71% of VDF and of 29 to 53% of HFP, which are used for the manufacture of molded PVDF bodies comprising from 1 to 30% by weight of fluorinated elastomer. However, such compositions are of limited extrudability and do not make possible the manufacture of pipes having a thickness/diameter ratio of close to 1/10. Furthermore, such compositions exhibit a fatigue strength insufficient for the applications described above.

The document EP 1 342 752 describes PVDF-based compositions comprising: (A) a PVDF homopolymer or a VDF-based copolymer; (B) a fluorinated elastomer; (C) optionally a plasticizer. The fluorinated elastomer (B) is present at a content of 0.5 to 10 parts by weight per 100 parts of homopolymer or copolymer (A) and of 0 to 10 parts by weight of a plasticizer (C) with the additional condition that the sum (9) plus (C) is from 0.5 to 10.5 parts by weight. These compositions correspond to the following proportions by weight: 89.5 to 90.5% of a PVDF homopolymer or a VDF-based copolymer (A); 0.5 to 9% of a fluorinated elastomer (B); 0 to 9% of a plasticizer (C). Disclosed among the examples are compositions comprising from 2 to 4% of VDF/HFP copolymer as fluorinated elastomer. The HFP content in the copolymer is from 30 to 40%.

The document EP 0 608 639 describes polymeric compositions comprising, by weight, from 60 to 80% of PVDF, from 20 to 40% of a thermoplastic copolymer of VDF and of another fluorinated comonomer (present at a content of 5 to 25% in the copolymer), and of 5 to 20% of a plasticizer (with respect to the sum of the PVDF and copolymer). VDF/HFP copolymers appear among the thermoplastic copolymers envisaged. The REP contents shown in the copolymers which are disclosed in the examples are of the order of 10%.

The document EP 0 608 940 describes polymeric compositions comprising, by weight, from 25 to 75% of PVDF and from 25 to 75% of thermoplastic copolymer of VDF and of another fluorinated comonomer (present at a content of 5 to 25% in the copolymer). VDF/HFP copolymers appear among the thermoplastic copolymers envisaged.

The document WO 2006/045753 describes polymeric compositions based on PVDF and on a thermoplastic fluorinated copolymer having an apparent melt viscosity of less than or equal to 60 000 Pa·s at a rate gradient of 1 sec⁻¹. A plasticizer can be added at a content of at most 5%. The thermoplastic fluorinated copolymer can, for example, be a copolymer of VDF and of another fluorinated comonomer, which can be present in a content of 5 to 2.5%. Characteristically, the blend of PVDF homopolymer and of fluorinated copolymer has a mean intrinsic viscosity of less than 2 dl/g.

However, the polymeric compositions proposed in the state of the art are not entirely satisfactory. In particular, the fatigue strength and/or the thermal resistance and the creep strength of the pipes manufactured from the polymeric compositions of the state of the art are considered inadequate for the applications targeted and very particularly for the manufacture of pipes for the transportation of fluids for off-shore and on-shore oil operation, and also for the transportation of liquid or gas synthesis products (for example, for the transportation of hydrogen).

There still exists a need to provide compositions of thermoplastic fluorinated polymers exhibiting a reduced high-temperature creep in combination with a good cold fatigue strength.

There also still exists a need to provide compositions of thermoplastic fluorinated polymers exhibiting improved properties for the manufacture of umbilicals and flexible pipes used in particular in off-shore operations.

### SUMMARY OF THE INVENTION

The invention relates first to a composition comprising:
from 60 to 80% by weight of a polyvinylidene fluoride;
from 10 to 30% by weight of a copolymer of vinylidene fluoride and of a comonomer;
a plasticizer; and
from 3 to 20% by weight of fibers.

Advantageously, the intrinsic viscosity of the blend of PVDF homopolymer and of fluorinated copolymer is greater than 2 dl/g.

According to one embodiment, the plasticizer is chosen from dibutyl sebacate, dioctyl phthalate, N-(n-butyl)sulfonatnide, polymeric polyesters and the combinations of these, and is preferably dibutyl sebacate.

According to one embodiment, the plasticizer is present in the composition in a proportion by weight of 1 to 5%, preferably of 1.5 to 3.5% and advantageously 1.5 to 2.5%.

According to one embodiment:
the proportion by weight of polyvinylidene fluoride is from 65 to 75%; and/or
the proportion by weight of the copolymer is from 10 to 30%, preferably from 15 to 25%; and/or
the proportion by weight of fibers is from 5 to 15%.

According to one embodiment, the proportion by weight of (co)monomer(s) other than vinylidene fluoride in the copolymer is within the range from 15 to 24%, preferably from 19 to 24%, limits included.

The intrinsic viscosity of the blend of the polyvinylidene fluoride homopolymer and of said vinylidene fluoride copolymer, in the absence of plasticizer, has been found to be greater than 2 dl/g, when it was measured in DMF (dimethylformamide) stabilized with 0.1M LiBr at 25° C. and at 4 g/l.

According to one embodiment, the apparent melt viscosity of the composition according to the invention is greater than 60 000 Pa·s at a rate gradient of 1 sec⁻¹. Surprisingly, it has been found that the composition according to the invention is particularly suitable for being processed by extrusion or coextrusion, which is contrary to what has been found in the abovementioned document WO 2006/045753 (page 4, 1.5-8).

According to one embodiment, the fluorinated comonomer is chosen from vinyl fluoride, trifluoroethylene, chlorotifluoroethylene (CITE), 1,2-difluoroethylene, tetrafluoroethylene (TFE), hexafluoropropylene (HFP), perfluoro(alkyl vinyl) ethers, such as perfluoro(methyl vinyl) ether (PMVE), perfluoro(ethyl vinyl) ether (PEVE) or perfluoro(propyl vinyl) ether (PPVE), perfluoro(1,3-dioxole), perfluoro(2,2-dimethyl-1,3-dioxole) (PDD), the product of formula CF₂═CFOCF₂CF(CF₃)OCF₂CF₂X in which X is SO₂F, CO₂H, CH₂OH, CH₂OCN or CH₂OPO₃H, the product of formula CF₂═CFOCF₂CF₂SO₂F, the product of formula F(CF₂)ₙCH₂OCF═CF₂ in which n is 1, 2, 3, 4 or 5, the product of formula R1CH₂OCF═CF₂ in which R1 is hydrogen or F(CF₂)_{z} and z has the value 1, 2, 3 or 4, the product of formula R3OCF═CH₂ in which R3 is F(CF₂)_{z} and z has the value 1, 2, 3 or 4, or also perfluorobutylethylene (PFBE), fluorinated ethylene propylene (FEP), 3,3,3-trifluoropropene, 2-trifluoromethyl-3,3,3-trifluoro-1-propene, 2,3,3,3-tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or FIFO-1234yc, 1,2,3,3-tetrafluoropropene or HFO-1234ye, 1,1,3,3-tetrafluoropropene or HFO-1234zc, and chlorotetrafluoropropene or HCFO-1224.

According to a preferred embodiment, the comonomer is hexafluoropropylene.

According to one embodiment, the copolymer is a terpolymer.

According to an embodiment, the fibers are chosen from carbon fibers, glass fibers, carbon nanotubes, carbon nanofibers, synthetic fibers and the combinations of these.

According to one embodiment, the fibers are crosslinked polyvinylidene fluoride fibers.

According to one embodiment, the above composition consists of the polyvinylidene fluoride homopolymer, the copolymer of vinylidene fluoride and of at least one other fluorinated comonomer which can be copolymerized with VDF, the plasticizer and the fibers.

According to a preferred embodiment which will be described in more detail below, the above composition consists of the polyvinylidene fluoride homopolymer, the VDF/HFP copolymer, the plasticizer and carbon fibers.

The invention also relates to a process for the manufacture of a composition as described above, comprising the blending of the polyvinylidene fluoride, the copolymer, the fibers and the plasticizer.

More particularly, the composition according to the invention is prepared by melt blending all the constituents on a compounding device, such as a twin-screw extruder, a co-kneader, an internal mixer or an open mill.

According to one embodiment, the homopolymer and the copolymer are in the dry form during the blending, preferably in the form of powders, and the blending with the plasticizer and the fibers is preferably carried out in the molten state on a compounding tool, such as a twin-screw extruder, a co-kneader, an internal mixer or an open mill.

According to one embodiment, the above process comprises the blending of the homopolymer and the copolymer in the latex form, the drying of the blend of homopolymer and copolymer and the combining of the dried blend with the plasticizer and the fibers is carried out in the molten state on a compounding tool, such as a twin-screw extruder, a co-kneader, an internal mixer or an open mill.

The composition according to the invention obtained by the manufacturing process described above can subsequently be transformed for use in the form of pipes or of cables, in particular using devices such as an extruder equipped with a suitable die, or also for use as binders for conductive particles.

Another subject matter of the invention is, generally, a pipe comprising at least one layer consisting of the composition according to the invention.

According to one embodiment, said pipe is intended to be employed as polymeric sheath for the flexible pipes used for the transportation of fluids of oil and gas operations. In this form, it can be used, in combination with at least one reinforcing layer and an external protective sheath, as flexible pipe for the transportation of fluids of oil or gas operations.

According to one embodiment, said pipe is a pipe for the on-shore transportation of products in the gas state.

According to one embodiment, the abovementioned pipe is for the transportation of synthesis products, in particular for the transportation of hydrogen, oxygen, steam, carbon monoxide, ammonia, hydrogen fluoride, hydrochloric acid, hydrogen sulfide, any gas resulting from the cracking of hydrocarbons, or mixtures of these.

According to one embodiment, said pipe is intended for the on-shore transportation of products in the liquid state, for example the transportation of water, solvents or mixtures of these.

According to one embodiment, the abovementioned pipe is an underground pipe for service stations or a fuel feed pipe for vehicles.

Another subject matter of the invention is an electric cable manufactured from the abovementioned composition.

Another subject matter of the invention is a binder for conductive particles for a rechargeable battery, manufactured from the abovementioned composition.

Another subject matter of the invention is the use of the composition described above in the manufacture of the abovementioned pipes, electric cables or binders for conductive particles.

The present invention makes it possible to overcome the disadvantages of the state of the art. It more particularly provides compositions of thermoplastic fluorinated polymers exhibiting a reduced high-temperature creep and/or a better cold fatigue strength.

It also provides compositions of thermoplastic fluorinated polymers exhibiting improved properties in the manufacture of umbilicals and flexible pipes used in particular in off-shore operations.

This is accomplished by virtue of the combination of a polyvinylidene fluoride, of a copolymer derived from vinylidene fluoride, of fibers and of plasticizer, within specific ranges.

In particular, the presence of fibers makes it possible to improve the creep strength at temperatures which can range up to 160 or 165° C., in combination with a good cold fatigue strength (fatigue at a temperature of less than 0° C.), which is configured mainly by the copolymer.

### DESCRIPTION OF EMBODIMENTS OF THE INVENTION

The invention is now described in more detail and without limitation in the description which follows.

Unless otherwise mentioned, all percentages shown correspond to proportions by weight.

The PVDF polymer used in the context of the invention preferably exhibits a melt flow index of less than or equal to 15 g/10 min, advantageously of less than or equal to 10 g/10 min and ideally of less than or equal to 5 g/10 min, according to the standard ISO 1133 (230° C., 12.5 kg), in order to guarantee good properties of mechanical strength.

The proportion by weight of this PVDF present in the composition can, for example, be from 60 to 62%; or from 62 to 64%; or from 64 to 66%; or from 66 to 68%; or from 68 to 70%; or from 70 to 72%; or from 72 to 74%; or from 74 to 76%; or from 76 to 78%; or from 78 to 80%.

The copolymer used in the context of the invention is a copolymer of vinylidene fluoride and of a comonomer. Preferably, it is a fluorinated comonomer.

Use may be made of combinations of several comonomers. For example, if two different comonomers are used, the copolymer is in reality a terpolymer (the proportion by weight of comonomer mentioned in the application then being understood as representing the proportion by weight of the sum of the comonomers).

Preferably, just one comonomer is present in the copolymer.

Furthermore, it is also possible to use a blend of two or more than two of the above copolymers, for example a blend of P(VDF-HFP) and of P(VDF-CTFE). In such a case, all the instructions relating to the proportion of copolymer in the composition are read as referring to the proportion of the combined copolymers in the composition.

However, it is preferred for just one copolymer to be present.

According to one embodiment, the comonomer is chosen from HFP, CTFE, CFE, TFE and TrFE.

Preferably, it is HFP: it is this example which is selected for the continuation of the description, it being understood that the latter is similarly valid when HFP is replaced with another comonomer.

The copolymer P(VDF-HFP) is obtained by copolymerization of VDF monomers and HFP monomers.

In the context of the invention, the content or proportion by weight of fluorinated (co)monomers is less than 25%. According to some embodiments, this proportion by weight of fluorinated (co)monomer is between 15 and 24% by weight, preferably between 19 and 24%.

The proportion by weight of fluorinated comonomer in the copolymer is preferably determined by nuclear magnetic resonance. Use may in particular be made of the following ¹⁹F NMR method, developed for a VDF/HFP copolymer. The copolymer samples are dissolved in an NMR tube with a diameter of 5 mm. The copolymer samples containing more than 10% by weight of HFP are dissolved in d₆-acetone at 55° C. An amount of copolymer (approximately 10 mg) is placed in a tube and solvent is added in order to fill 5.5 cm of tube (approximately 0.75 ml of solvent). A heating plate is used to bring the samples to the desired temperature. The samples are heated for at least one hour until the solid has dissolved and the gel has disappeared. The tubes are inverted in order to confirm the absence of gel.

The spectra are acquired on a spectrometer of Bruker DMX or Varian Mercury 300 type operated at 55° C. in the case of the solvent d₆-acetone and are analyzed according to the method described in “Composition and sequence distribution of vinylidene fluoride copolymer and terpolymer fluoroelastomers. Determination by ¹⁹F NMR spectroscopy and correlation with some properties”, M. Pianca et al., Polymer, 1987, vol. 28. 224-230. The accuracy of the measurements is confirmed by measuring the integrals of CF:., and of CF and by comparing them in order to see if they are indeed in a ratio of 3 to 1.

Preferably, the copolymer used for the preparation of the composition according to the invention is essentially devoid of homopolymer.

The copolymer can be manufactured by the process described in the abovementioned publication by M. Pianca et al.

The plasticizers within the meaning of the invention are the compounds defined in the work Encyclopedia of Polymer Science and Engineering, published by Wiley &. Sons (1989), pp. 568-569 and pp. 588-593. They can be monomeric or polymeric. Mention may in particular be made of dibutyl sebacate, dioctyl phthalate, N-(n-butyl)sulfonamide, polymeric polyesters and the combinations of these. The appropriate polymeric polyesters are in particular those derived from adipic acid, azelaic acid or sebacic acid and diols, and the combinations of these, the molecular weight preferably being greater than or equal to 1500, more particularly greater than or equal to 1800, and preferably less than or equal to 5000, and more particularly less than or equal to 2500. Plasticizers having excessive molecular weights would result in a composition exhibiting an excessively low impact strength.

Dibutyl sebacate constitutes in particular an advantageous plasticizer.

The presence of the plasticizer facilitates the manufacture of the composition according to the invention or its transformation in order to manufacture various products or articles. It also improves the impact strength of the composition according to the invention.

Preferably, the copolymer used in the preparation of the composition according to the invention is essentially devoid of homopolymer.

The copolymer can in particular be manufactured according to the method described in the patent EP 1 144 469 B1.

The proportion by weight of the above copolymer (and in particular of P(VDF-HFP)) in the composition can, for example, be from 10 to 12%; or from 12 to 14%; or from 14 to 16%; or from 16 to 18%; or from 18 to 20%; or from 20 to 22%; or from 22 to 24%; or from 24 to 26%; or from 26 to 28%; or from 28 to 30%.

Use may also be made, as plasticizer, of PVDF or a VDF-derived copolymer (for example P(VDF-HFP)) exhibiting a lower viscosity than the PVDF and the P(VDF-HFP) which are described above and which represent the two main constituents of the composition. This plasticizing PVDF or copolymer can thus have a viscosity, under 100 s⁻¹ and at a temperature of 230° C., which is lower than the viscosity of the predominant PVDF by a factor of at least equal to 5, or at least equal to 10, or at least equal to 20, or at least equal to 30. For example, this plasticizing PVDF or copolymer can have a viscosity of 50 to 300 Pa·s, under 100 s⁻¹ and at a temperature of 230° C.

The composition according to the invention also comprises fibers.

The term “fibers” denotes structures of elongated shape or of filamentary type. The fibers exhibit a length along a longitudinal direction (corresponding to the maximum dimension of the structure) and a diameter (defined as being the maximum dimension of the structure perpendicularly to the longitudinal direction), the length being greater than the diameter by a factor of at least 10, preferably at least 50 or at least 100.

Use may in particular be made of polymeric fibers, for example drawn polymer fibers. Use may thus be made of fibers of polyamide, such as polyamide 6 (PA-6), polyamide 11 (PA-11), polyamide 12 (PA-12), polyamide 6.6 (PA-6.6), polyamide 4.6 (PA-4.6), polyamide 6.10 (PA-6.10) or polyamide 6.12 (PA-6.12), of polyamide/polyether block copolymer (sold under the Pebax® name), of high-density polyethylene, of polypropylene or of polyester, for example polyhydroxyalkanoates and polyesters (sold by DuPont under the Hytrel® trade name).

Other possible polymeric fibers are crosslinked PVDF fibers. These can be obtained by extrusion of PVDF, followed by irradiation in order to bring about crosslinking. A crosslinking agent can be added in order to facilitate the crosslinking, such as an aromatic or nonaromatic bisimide or also triallyl cyanurate or triallyl isocyanurate.

The use of crosslinked PVDF fibers exhibits the advantage of good compatibility between the fibers and the polymer matrix. In that way, good tying of the fibers in the matrix is obtained, damage to the matrix by the fibers is avoided and a saving in weight is achieved, in comparison, for example, with glass fibers.

Use may also be made of carbon fibers.

Use may also be made of glass fibers, in particular of E, R or S2 type.

Use may also be made of aramid fibers (trade name Kevlarg).

Use may also be made of boron fibers.

Use may also be made of silica fibers.

Use may also be made of natural fibers, such as flax, hemp or sisal.

For all of the above fibers, the mean diameter is advantageously from 2 to 100 μm, preferably from 10 to 20 μm, and the mean length is advantageously from 0.5 to 10 mm, preferably from 2 to 4 mm. These are means by number, over all of the fibers.

Use may also be made, as fibers, of carbon nanotubes.

Carbon nanotubes are hollow tubular structures comprising a graphite plane positioned around a longitudinal axis or several graphite planes (or sheets) positioned concentrically around a longitudinal axis.

Carbon nanotubes can be of the single-walled, double-walled or multi-walled type. Double-walled nanotubes can in particular be prepared as described by Flahaut et al. in Chem. Comm. (2003), p. 1442. nanotubes can be prepared as described in the document WO 03/02456.

Carbon nanotubes generally have a mean diameter (perpendicular to the longitudinal axis, the mean value being a linear mean along the longitudinal axis and a statistical mean over an assembly of nanotubes) ranging from 0.4 to 100 nm, preferably from 1 to 50 nm and better still from 2 to 30 nm, indeed even from 10 to 15 nm, and advantageously a length from 0.1 to 10 μm. The length/diameter ratio is preferably greater than 10 and most often greater than 100. Their specific surface has a value, for example, of from 100 to 300 m²/g, advantageously from 200 to 300 m²/g, and their bulk density can in particular have a value of from 0.05 to 0.5 g/cm³ and more preferably from 0.1 to 0.2 g/cm³. Multi-walled nanotubes can, for example, comprise from 5 to 15 sheets (or walls) and more preferably from 7 to 10 sheets. These nanotubes may or may not be treated.

The dimensions and in particular the mean diameter of the carbon nanotubes can be determined by transmission electron microscopy.

An example of crude carbon nanotubes is in particular by Arkema under the trade name Graphi strength® C100.

These carbon nanotubes can be purified and/or treated (for example oxidized) and/or ground and/or functionalized, before they are employed in the context of the invention.

The grinding of the carbon nanotubes can in particular be carried out under cold conditions or under hot conditions and can be carried out according to the known techniques employed in devices such as ball, hammer, edge runner, knife or gas jet mills or any other grinding system capable of reducing the size of the entangled network of nanotubes. It is preferable for this grinding stage to be carried out according to a gas jet grinding technique and in particular in an air jet mill.

The crude or ground carbon nanotubes can be purified by washing using a sulfuric acid solution, so as to free them from possible residual inorganic and metallic impurities, such as, for example, iron, originating from their preparation process. The weight ratio of the nanotubes to the sulfuric acid can in particular have a value of from 1:2 to 1:3. The purification operation can furthermore be carried out at a temperature ranging from 90° C. to 120° C., for example for a period of time of 5 to 10 hours. This operation can advantageously be followed by stages in which the purified carbon nanotubes are rinsed with water and dried. In an alternative form, the carbon nanotubes can be purified by high temperature heat treatment, typically at greater than 1000° C.

The oxidation of the carbon nanotubes is advantageously carried out by bringing the latter into contact with a sodium hypochlorite solution including from 0.5% to 15% by weight of NaOC1 and preferably from 1% to 10% by weight of NaOCl, for example in a weight ratio of the carbon nanotubes to the sodium hypochlorite ranging from 1:0.1 to 1:1. The oxidation is advantageously carried out at a temperature of less than 60° C. and preferably at ambient temperature, for a period of time ranging from a few minutes to 24 hours. This oxidation operation can advantageously be followed by stages in which the oxidized nanotubes are filtered and/or centrifuged, washed and dried.

The functionalization of the carbon nanotubes can be cat tied out by grafting reactive units, such as vinyl monomers, to their surface. The constituent material of the carbon nanotubes is used as radical polymerization initiator after having been subjected to a heat treatment at more than 900° C., in an anhydrous medium devoid of oxygen, which is intended to remove the oxygen-comprising groups from its surface. It is thus possible to polymerize methyl methacrylate or hydroxyethyl methacrylate at the surface of carbon nanotubes for the purpose of facilitating in particular their dispersion in the polyamides.

Use is preferably made, in the present invention, of crude carbon nanotubes, that is to say carbon nanotubes which are neither oxidized nor purified nor functionalized and which have not been subjected to any other chemical and/or heat treatment, which are optionally ground.

Use may also be made, as fibers, of carbon nanofibers.

Carbon nanofibers are objects of filamentary form. Unlike carbon nanotubes, they are not hollow objects. By way of example, carbon nanofibers can have a herringbone structure (stack of graphene layers oriented symmetrically on either side of a longitudinal axis), or a platelet or lamellar structure (graphene sheets stacked perpendicularly to the axis), or a conical structure, also known as stacked cup structure (continuous graphene sheet wound over itself), or a “bamboo-like” structure (fiber exhibiting periodic variations in diameter, formed of compartments separated by a graphite sheet), or a ribbon structure (graphene sheets oriented parallel to the longitudinal axis without being wound), or a tubular structure (similar to the structure of multi-walled carbon nanotubes).

Carbon nanofibers can have a mean diameter (perpendicular to the longitudinal axis, the mean value being a linear mean along the longitudinal axis and a statistical mean over an assembly of nanofibers) ranging from 0,4 to 100 nm, preferably from 1 to 50 nm and better still from 2 to 30 nm, indeed even from 10 to 15 nm, and advantageously a length from 0.1 to 10 μm. The length/diameter ratio is preferably greater than 10 and most often greater than 100.

The dimensions and in particular the mean diameter of the carbon nanofibers can be determined by scanning electron microscopy.

Use may also be made of mixtures of two or more than two types of preceding fibers.

The proportion of fibers in the composition can, for example, be from 3 to 4%; or from 4 to 5%; or from 5 to 6%; or from 6 to 7%; or from 7 to 8%; or from 8 to 9%; or from 9 to 10%; or from 10 to 11%; or from 11 to 12%; or from 12 to 13%; or from 13 to 14%; or from 14 to 15%; or from 15 to 16%; or from 16 to 17%; or from 17 to 18%; or from 18 to 19%; or from 19 to 20%.

According to one embodiment, the composition according to the invention consists of the PVDF, the P(VDF-HFP), the plasticizer and the fibers.

Alternatively, provision may be made to add one or more additives, in particular a manufacturing additive, such as a lubricant. Mention may in particular be made of stearates, such as calcium stearate or zinc stearate, natural waxes and polytetrafluoroethylene and its derivatives, When a manufacturing additive is present, it is typically included in a proportion by weight of 0.01 to 0.3%, preferably of 0.02 to 0.1%. According to one embodiment, the composition according to the invention consists of the PVDF, the P(VDF-HFP), the plasticizer, the fibers and a manufacturing additive.

Examples of formulations for the composition according to the invention appear in the table below (the amount of plasticizer and of additives not being specified):

| | Proportion | Proportion of | Proportion |
|---|---|---|---|
| Formulation No. | of PVDF | P(VDF-HFP) | of fibers |
| 1 | 60 to 64% | 10 to 14% | 3 to 5% |
| 2 | 60 to 64% | 10 to 14% | 5 to 8% |
| 3 | 60 to 64% | 10 to 14% | 8 to 12% |
| 4 | 60 to 64% | 10 to 14% | 12 to 15% |
| 5 | 60 to 64% | 10 to 14% | 15 to 20% |
| 6 | 60 to 64% | 14 to 18% | 3 to 5% |
| 7 | 60 to 64% | 14 to 18% | 5 to 8% |
| 8 | 60 to 64% | 14 to 18% | 8 to 12% |
| 9 | 60 to 64% | 14 to 18% | 12 to 15% |
| 10 | 60 to 64% | 14 to 18% | 15 to 20% |
| 11 | 60 to 64% | 18 to 22% | 3 to 5% |
| 12 | 60 to 64% | 18 to 22% | 5 to 8% |
| 13 | 60 to 64% | 18 to 22% | 8 to 12% |
| 14 | 60 to 64% | 18 to 22% | 12 to 15% |
| 15 | 60 to 64% | 18 to 22% | 15 to 20% |
| 16 | 60 to 64% | 22 to 26% | 3 to 5% |
| 17 | 60 to 64% | 22 to 26% | 5 to 8% |
| 18 | 60 to 64% | 22 to 26% | 8 to 12% |
| 19 | 60 to 64% | 22 to 26% | 12 to 15% |
| 20 | 60 to 64% | 26 to 30% | 3 to 5% |
| 21 | 60 to 64% | 26 to 30% | 5 to 8% |
| 22 | 60 to 64% | 26 to 30% | 8 to 12% |
| 23 | 64 to 68% | 10 to 14% | 3 to 5% |
| 24 | 64 to 68% | 10 to 14% | 5 to 8% |
| 25 | 64 to 68% | 10 to 14% | 8 to 12% |
| 26 | 64 to 68% | 10 to 14% | 12 to 15% |
| 27 | 64 to 68% | 10 to 14% | 15 to 20% |
| 28 | 64 to 68% | 14 to 18% | 3 to 5% |
| 29 | 64 to 68% | 14 to 18% | 5 to 8% |
| 30 | 64 to 68% | 14 to 18% | 8 to 12% |
| 31 | 64 to 68% | 14 to 18% | 12 to 15% |
| 32 | 64 to 68% | 14 to 18% | 15 to 20% |
| 33 | 64 to 68% | 18 to 22% | 3 to 5% |
| 34 | 64 to 68% | 18 to 22% | 5 to 8% |
| 35 | 64 to 68% | 18 to 22% | 8 to 12% |
| 36 | 64 to 68% | 18 to 22% | 12 to 15% |
| 37 | 64 to 68% | 22 to 26% | 3 to 5% |
| 38 | 64 to 68% | 22 to 26% | 5 to 8% |
| 39 | 64 to 68% | 22 to 26% | 8 to 12% |
| 40 | 64 to 68% | 26 to 30% | 3 to 5% |
| 41 | 64 to 68% | 26 to 30% | 5 to 8% |
| 42 | 68 to 72% | 10 to 14% | 3 to 5% |
| 43 | 68 to 72% | 10 to 14% | 5 to 8% |
| 44 | 68 to 72% | 10 to 14% | 8 to 12% |
| 45 | 68 to 72% | 10 to 14% | 12 to 15% |
| 46 | 68 to 72% | 10 to 14% | 15 to 20% |
| 47 | 68 to 72% | 14 to 18% | 3 to 5% |
| 48 | 68 to 72% | 14 to 18% | 5 to 8% |
| 49 | 68 to 72% | 14 to 18% | 8 to 12% |
| 50 | 68 to 72% | 14 to 18% | 12 to 15% |
| 51 | 68 to 72% | 18 to 22% | 3 to 5% |
| 52 | 68 to 72% | 18 to 22% | 5 to 8% |
| 53 | 68 to 72% | 18 to 22% | 8 to 12% |
| 54 | 68 to 72% | 22 to 26% | 3 to 5% |
| 55 | 68 to 72% | 22 to 26% | 5 to 8% |
| 56 | 72 to 76% | 10 to 14% | 3 to 5% |
| 57 | 72 to 76% | 10 to 14% | 5 to 8% |
| 58 | 72 to 76% | 10 to 14% | 8 to 12% |
| 59 | 72 to 76% | 10 to 14% | 12 to 15% |
| 60 | 72 to 76% | 14 to 18% | 3 to 5% |
| 61 | 72 to 76% | 14 to 18% | 5 to 8% |
| 62 | 72 to 76% | 14 to 18% | 8 to 12% |
| 63 | 72 to 76% | 18 to 22% | 3 to 5% |
| 64 | 72 to 76% | 18 to 22% | 5 to 8% |
| 65 | 76 to 80% | 10 to 14% | 3 to 5% |
| 66 | 76 to 80% | 10 to 14% | 5 to 8% |
| 67 | 76 to 80% | 10 to 14% | 8 to 12% |
| 68 | 76 to 80% | 14 to 18% | 3 to 5% |
| 69 | 76 to 80% | 14 to 18% | 5 to 8% |

According to an embodiment, for each of the formulations 1 to 69 above, the proportion by weight of HFP comonomer in the copolymer has a value from 20 to 22%.

According to an embodiment, for each of the formulations 1 to 69 above, the proportion by weight of HFP comonomer in the copolymer has a value from 22 to 24%.

According to an embodiment, for each of the formulations 1 to 69 above, the proportion by weight of FIEF comonomer in the copolymer has a value from 24 to 26%.

According to an embodiment, for each of the formulations 1 to 69 above, the proportion by weight of HFP comonomer in the copolymer has a value from 26 to 28%.

According to an embodiment, for each of the formulations 1 to 69 above, the proportion by weight of HFP comonomer in the copolymer has a value from 28 to 30%.

According to an embodiment, for each of the formulations 1 to 69 above, the proportion by weight of HFP comonomer in the copolymer has a value from 30 to 35%.

According to an embodiment, for each of the formulations 1 to 69 above, the proportion by weight of HFP comonomer in the copolymer has a value from 35 to 40%.

According to one embodiment, for each of the formulations 1 to 69 above, the HFP comonomer can be replaced with a CTFE comonomer.

According to one embodiment, for each of the formulations 1 to 69 above, the HFP comonomer can be replaced with a TFE comonomer.

According to one embodiment, for each of the formulations 1 to 69 above, the HFP comonomer can be replaced with a TrFE comonomer.

According to one embodiment, for each of the formulations 1 to 69 above, the HFP comonomer can be replaced with a CFE comonomer.

The composition according to the invention can be manufactured by melt blending the PVDF and the P(VDF-HFP) (subsequently powders or granules) in an extruder, an open mill or any other type of appropriate device.

The plasticizer, the fibers and also the optional additives can be incorporated in the compositions during the blending of the PVDF and the P(VDF-HFP), or also be blended with one or other of these constituents prior to the blending thereof, or also subsequently to the blending of the PVDF and the P(VDF-HFP), or also be introduced into the form of a masterbatch introducing a portion of one of the two constituents (PVDF or P(VDF-HFP)), according to the blending techniques set out above.

Preferably, the fibers exhibit a preferred orientation in the composition. This is accomplished, for example, by virtue of an aligning of the fibers during an extrusion stage.

The composition according to the invention makes it possible to manufacture umbilicals and flexible pipes used on-shore and off-shore (in a marine environment) in order to contain and/or transport crude oil, natural gas, water and other gases used for drilling, as defined in the standards API 17J, API 16C and API 15RS.

The composition according to the invention also makes it possible to manufacture any type of pipe for the transportation of gas or liquid products, in particular intended to transport gas products for the synthesis of chemicals or intended to transport products for individual, industrial or public consumption.

The composition according to the invention also makes it possible to manufacture, alone or in combination with other products, cables, hollow bodies or binders for rechargeable batteries.

The composition according to the invention can be employed in the form of a layer in a multilayer structure or it can be used to form a part in full.

The manufacture of the above articles is preferably carried out by extrusion, the composition being directly formed during the extrusion. Alternatively, the composition. can first be prepared in the firm of granules and can then be melted and extruded for the shaping of the articles.

The composition according to the invention can be tested by means of the fatigue test, which is described in the document WO 2010/026356. It consists in determining, for a given sample of polymeric composition, the number of cycles to failure (denoted NU), that is to say the number of cycles at the end of which failure of the sample occurs. The higher the NCF value, the better the result in the fatigue test.

In order to carry out a fatigue test, axisymmetric test specimens are cut out from a thickness of an extruded pipe, with a notch radius of curvature of 4 mm and a minimum radius of 2 mm. These test specimens are regarded as being representative of the local geometry of the pipe. The cutting out is carried out by means of a servo-hydraulic testing machine, for example of MTS 810 type. The distance between the jaws is 10 mm. A maximum elongation of 1.4 mm and a ratio of the minimum elongation to the maximum elongation of 0.21, which corresponds to a minimum elongation of 0.3 mm, with a sinusoidal signal having a frequency of 1 Hz, is applied to the test specimen. The result of the test (NCF) is the mean of the results obtained on 10 test specimens.

In order to carry out a hot creep test, a tensile test is carried out according to the standard ISO 527 (test specimens of type 1 A at the rate of 50 mm/min) on nonaged test specimens of the polymeric composition, with conditioning of these test specimens at a test temperature (which can, for example, be 130° C., or 150° C., or 165° C.), 20 minutes before the test. The yield stress of these test specimens corresponds to the maximum nominal stress withstood by the test specimens during the tensile testing. The higher the stress, the better the creep strength of the polymeric composition at the test temperature under consideration.

### EXAMPLES

The following examples illustrate the invention without limiting it.

### Example 1

A composition according to the invention having the following formulation is prepared:
69% of Kynar® 401 polymer (PVDF homopolymer, Arkema);
18% of Kynar Ultraflex® copolymer (VDF-HFP copolymer containing between 23 and 24% by weight of HIV, origin: Arkema);
3% of dibutyl sebacate (plasticizer);
10% of carbon fibers.

The composition is obtained by melt blending powders or granules comprising the two polymeric compounds and also the plasticizer and the fibers on a co-kneader of PR 46 type of Buss brand with a diameter of 46 millimeters, with a length 15 times greater than its diameter and equipped with a recovery extruder, at a throughput of 10 kg/h. The rotational speed of the screw of the co-kneader is 150 rev/min and that of the recovery extruder is approximately 15 rev/min. The temperature profile is set so as to obtain an internal temperature of between 200° C. and 230° C.

The granules obtained are subsequently extruded as a strip or as a pipe with a thickness of between 6 and 10 mm using a single-screw extruder equipped with a suitable die. The temperature profile is set so as to obtain an internal temperature of between 210° C. and 250° C.

### Example 2

Another composition according to the invention is prepared with the same formulation as in the preceding example, except that the 10% of carbon fibers are replaced with 10% of crosslinked PVDF fibers.

The first stage is the preparation of the crosslinked PVDF fibers. These are prepared by extrusion of Kynar® 705 polymer (PVDF homopolymer exhibiting a viscosity, at 230° C. under 100 s⁻¹, of 250 Pa·s, sold by Arkema). The diameter of the fibers is between 10 and 20 _{f}am and their length is between 2 and 4 mm.

These fibers are irradiated under 50 kgray with a source of cobalt-60, bringing about their crosslinking. These fibers are subsequently introduced at a content of 10% into the formulation, according to the following protocol.

The composition is obtained by melt blending powders or granules comprising the two polymeric compounds and also the plasticizer and the fibers on a co-kneader of PR 46 type of Buss brand with a diameter of 46 millimeters, with a length 15 times greater than its diameter and equipped with a recovery extruder, at a throughput of 10 kg/h. The rotational speed of the screw of the co-kneader is 150 rev/min and that of the recovery extruder is approximately 15 rev/min and the temperature profile is set so as to obtain an internal temperature of between 200° C. and 230° C.

The granules obtained are subsequently extruded as a strip or as a pipe with a thickness of between 6 and 10 mm using a single-screw extruder equipped with a suitable die. The temperature profile is set so as to obtain an internal temperature of between 210° C. and 250° C.)

1. A composition comprising:
from 60 to 80% by weight of a polyvinylidene fluoride;
from 10 to 30% by weight of a copolymer of vinylidene fluoride and of at lease one comonomer;
a plasticizer present in the composition in a proportion by weight of 1 to 5%; and
from 3 to 20% by weight of fibers.

2. The composition as claimed in claim 1, in which the plasticizer is chosen from dibutyl sebacate, dioctyl phthalate, N-(n-butyl)-sulfonamide, polymeric polyesters and the combinations of these.

3. The composition as claimed in claim 1, in which the plasticizer is present in a proportion by weight of 1,5 to 3.5%.

4. The composition as claimed in claim 1, in which the fibers are chosen from carbon fibers, glass fibers, carbon nanotubes, carbon nanofibers, synthetic fibers and the combinations of these.

5. The composition as claimed in claim 1, in which the fibers are crosslinked polyvinylidene fluoride fibers.

6. The composition as claimed in claim 1, in which the copolymer is present in a proportion by weight of 15 to 25%.

7. The composition as claimed in claim 1, in which the proportion by weight of (co)monomer(s) other than vinylidene fluoride in the copolymer is within the range from 15 to 24%.

8. The composition as claimed in claim 1, in which the fluorinated comonomer(s) are chosen from the group it fluoromonomers consisting of vinyl fluoride, trifluoroethylene, chlorotrifluoroethylene (CITE), 1,2-difluoroethylene, tetraftuoroethylene (TEE), hexafluoropropylene (HFP), perfluoro(alkyl vinyl) ethers, perfluoro(methyl vinyl) ether (PMVE), perfluoro(ethyl vinyl) ether (PINE) perfluoropropyl vinyl ether (PPVE), perfluoro(1,3-dioxole), perfluoro(2,2-dimethyl-1,3-dioxole) (PDD), the product of formula CF₂═CFOCF₂CF(CF₃)OCF₂CF₂X in which X is SO₂F, CO₂H, CH₂OH, CH₂OCN or CH₂OPO₃H, the product of formula CF₂═CFOCF₂CF₂SO₂F, the product of formula F(CF₂)ₙCH₂OCF═CF₂ in which n is 1, 2, 3, 4 or 5, the product of formula R1CH₂OCF═CF₂ in which R1 is hydrogen or F(CF₂)_{z} and z has the value 1, 2, 3 or 4, the product of formula R3OCF═CH₂ in which R3 is F(CF₂), and z has the value 1, 2, 3 or 4, perfluorobutylethylene (PFBE), fluorinated ethylene propylene (FEP), 3,3,3-trifluoropropene, 2-trifluoromethyl-3,3,3-trifluoro-1-propene, 2,3,3,3-tetrafluoropropene, HFO-1234yf, E-1,3,3,3-tetrafluoropropene, HFO-1234zeE, Z-1,3,3,3-tetrafluoropropene, HFO-1234zeZ, 1,1,2,3-tetra-fluoropropene, HFO-1234yc, 1,2,3,3-tetrafluoropropene, HFO-1234ye, 1,1,3,3-tetrafluoropropene, HFO-1234n, and chlorotetrafluoropropene, HCFO-1224.

9. The composition as claimed in claim 1, in which the comonomer is hexafluoropropylene.

10. The composition as claimed in claim 1, in which the intrinsic viscosity of the blend of PVDF homopolymer and of fluorinated copolymer is greater than 2 dl/g.

11. The composition as claimed in claim 1, having an apparent melt viscosity of greater than 60 000 Pa·s at a rate gradient of 1 sec⁻¹.

12. The composition as claimed in claim 1, consisting of the polyvinylidene fluoride homopolymer, the copolymer of vinylidene fluoride and of hexafluoropropylene, the carbon fibers and the plasticizer.

13. A process for the manufacture of a composition as claimed in claim 1, comprising the blending of the polyvinylidene fluoride, the copolymer, the fibers and the plasticizer.

14. The process as claimed in claim 13, in which the homopolymer and the copolymer are in the dry form during the blending with the plasticizer, preferably in the form of powders.

15. The process as claimed in claim 13, comprising the blending of the homopolymer and the copolymer in the latex form, the drying of the blend of homopolymer and copolymer and the combining of the dried blend with the plasticizer and the fibers.

16. A pipe-comprising at least one layer consisting of a composition as claimed in claim 1.

17. The pipe of claim 16, wherein said layer consisting of the composition of claim 1 is a polymeric sheath for flexible pipes used for the transportation of fluids of oil and gas operations.

18. The composition as claimed in claim 2, in which the plasticizer is dibutyl sebacate in a proportion by weight of 1.5 to 2.5%.

19. The composition as claimed in claim 1 in which the proportion by weight of (co)monomer(s) other than vinylidene fluoride in the copolymer is within the range from 19 to 24%, limits included.

20. The process as claimed in claim 14, in which the homopolymer and the copolymer are in the dry form during the blending with the plasticizer, preferably in the form of powders, and the blending is preferably carried out in the molten state.
